(19) United States
(12) Patent Application Publication
(10) Pub. No.: US 2025/0379269 A1
(43) Pub. Date: Dec. 11, 2025

(54) BATTERY MANAGEMENT SYSTEM

(71) Applicant: DYNAPACK INTERNATIONAL TECHNOLOGY CORPORATION, Taoyuan City (TW)

(72) Inventors: Chung-Hsing CHANG, Taoyuan City (TW); Wen-Yi CHEN, Taoyuan City (TW); Hung-Sheng CHEN, Taoyuan City (TW); Shih-Chieh SHAO, Taoyuan City (TW); Yu-Kai CHOU, Taoyuan City (TW)

(21) Appl. No.: 18/736,006

(22) Filed: Jun. 6, 2024

(51) Int. Cl. H01M 10/42; H01M 10/48; H01M 50/572

(52) U.S. Cl. CPC H01M 10/425; H01M 10/482; H01M 50/572; H01M 2010/4271; H01M 2200/106

(57) ABSTRACT

A battery management system is used to discharge an input capacitor of a load, and the battery management system includes a battery pack, a main discharge loop, a pre-discharge loop, and a controller. The pre-discharge loop sets a rated current, and the controller selectively controls a conduction of the main discharge loop or the pre-discharge loop to provide a battery power from the battery pack to the load. When the load is coupled to the battery management system, the controller first turns on the pre-discharge loop for a specific time, and then turns on the main discharge loop. The pre-discharge loop limits a current to be approximately equal to the rated current according to the current flowing through reaching the rated current at a specific time.

### BACKGROUND

### Technical Field

The present disclosure relates to a battery management system, and more particularly to a battery management system with constant current pre-discharge function.

### Description of Related Art

A battery management system is a system that manages battery. It usually has the functions of measuring battery voltage, current, temperature and/or other parameter(s) to manage them according to their parameter(s), so as to prevent or avoid the abnormal conditions such as battery over-discharge, over-charge, and over-temperature. Among them, the management object of the battery management system can generally be a rechargeable secondary battery. In recent years, the battery management system is mainly used with lithium battery to perform charging and discharging operations, and with the development of technology, many functions have been gradually added.

In general, common applications of the battery management system is nothing more than 3 C product(s) and electric machine(s). In recent years, the battery management system is widely used in the technical field of electric vehicle (for example, but not limited to, electric car, electric motorcycle, electric bicycle, etc.). In the technical field where the battery management system is applied to electric vehicle, electric vehicle requires relatively high current. Moreover, the current often fluctuates significantly depending on the user's operations. Therefore, the input capacitor of electric vehicle usually uses a large-capacity capacitor.

Since the input capacitor is equivalent to a short circuit when the input capacitor is no power, a current that large will generally be generated when the battery management system is connected to an electric vehicle instantly. Especially in applications where the input capacitor is the large-capacity capacitor, a peak value of the surge current will be higher. Such the surge current that largely may easily damage system component(s) or reduce their service life, and may even reversely impact component(s) inside the battery management system.

Therefore, it is a major topic for the inventors of the present disclosure to design a battery management system to suppress the surge current generated when an electric vehicle is connected instantly, and reduce the peak value of the surge current when it occurs.

### SUMMARY

In order to solve the above-mentioned problems, the present disclosure provides a battery management system. The battery management system discharges a load having an input capacitor, and the battery management system includes a battery pack, a main discharge loop, a pre-discharge loop and a controller. the main discharge loop is coupled to the battery pack and the input capacitor, and the pre-discharge loop is connected in parallel with the main discharge loop, and sets a rated current. The controller is coupled to the main discharge loop and the pre-discharge loop, and selectively controls a conduction of the main discharge loop or the pre-discharge loop to provide a battery power of the battery pack to the load. Wherein, the controller first turns on the pre-discharge loop for a specific time, and then turns on the main discharge loop when the load is coupled to the battery management system, and the pre-discharge loop limits a current substantially equal to the rated current according to the current flowing through the pre-discharge loop reaching the rated current at the specific time.

In one embodiment, the pre-discharge loop includes a switch and a constant current component, and the switch is coupled to one end of the main discharge loop. One end of the constant current component is coupled to the switch and the other end of the constant current component is coupled to the other end of the main discharge loop. Wherein, the controller controls the switch to be turned on, and the constant current component limits the current substantially equal to the rated current according to the current flowing through the constant current component reaching the rated current at the specific time.

In one embodiment, the constant current component includes at least one current regulative diode.

In one embodiment, the number of the at least one current regulative diode is proportional to a level of the rated current.

In one embodiment, the pre-discharge loop further includes a temperature protection component. The temperature protection component is coupled to the switch and the constant current component, and the temperature protection component provides an over-temperature protection of the pre-discharge loop.

In one embodiment, the temperature protection component is a positive temperature coefficient resistor and provides an impedance corresponding to a change with temperature, and a level of the rated current is inversely proportional to a level of the impedance.

In one embodiment, the battery management system further includes a first detection circuit. The first detection circuit is coupled to the battery pack and the controller, and detects the battery pack to provide a battery pack parameter corresponding to the battery power. Wherein, the controller determines whether the battery pack is normal according to the battery pack parameter, so as to determine whether to provide the battery power to the load.

In one embodiment, the battery pack includes a plurality of batteries, and the first detection circuit detects a plurality of battery parameters of the batteries, so as to provide the battery pack parameter.

In one embodiment, the battery management system further includes a second detection circuit. The second detection circuit is coupled to the pre-discharge loop and the controller, and the controller determines whether the battery management system being discharged the load normally according to a voltage and a current of the pre-discharge loop at the specific time, so as to determine whether to turn on the main discharge loop.

In one embodiment, a rising slope of a discharge voltage of the input capacitor is substantially a constant slope during a specific time period of the specific time.

In one embodiment, the main purpose and effect of the present disclosure is that the battery management system of the present disclosure may first turn on the pre-discharge loop to provide a smaller current to discharge the load, and then turn on the main discharge loop to provide a larger current to discharge the load, so as to suppress the surge current when the battery management system is connected to the load instantly. Moreover, during the specific time when the controller turns on the pre-discharge loop, the pre-discharge loop limits the current substantially equal to the rated current according to the current flowing through it reaching the rated current, so as to achieve an effect that further suppressing a peak value of the surge current and avoiding a sudden peak value excessively that may cause abnormality in the battery management system or the load (system).

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a battery management system of the present disclosure.

FIG. 2A is a block circuit diagram of a pre-discharge loop of the present disclosure.

FIG. 2B is a characteristic curve diagram of a current regulative diode of the present disclosure.

FIG. 3A is a schematic waveform diagram of a constant current component using the current regulative diode of the present disclosure.

FIG. 3B is a schematic waveform diagram of the main discharge loop being turned on at time t2 in FIG. 3A.

FIG. 4A is a schematic waveform diagram in which the constant current component is replaced with a current limit component using a resistor of the present disclosure.

FIG. 4B is a schematic waveform diagram of the main discharge loop being turned on at time t2 in FIG. 4A.

### DETAILED DESCRIPTION

Reference will now be made to the drawing figures to describe the present disclosure in detail. It will be understood that the drawing figures and exemplified embodiments of present disclosure are not limited to the details thereof.

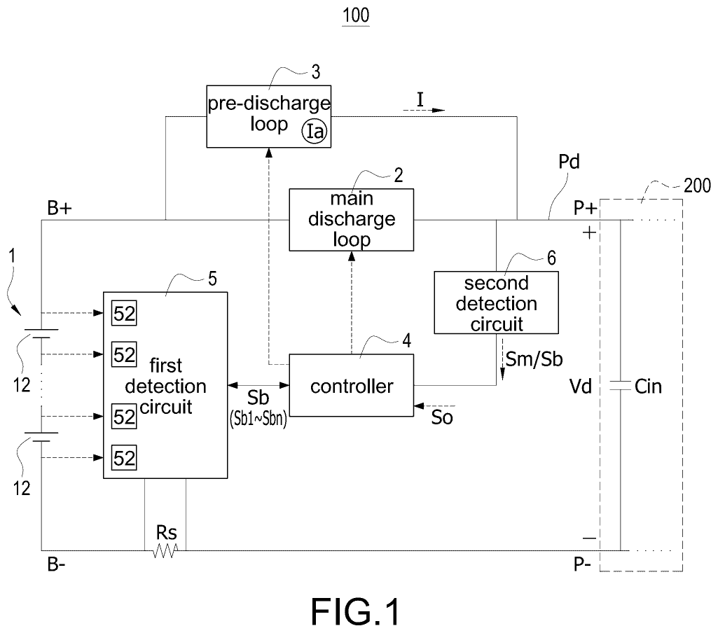

Please refer to FIG. 1, which shows a block circuit diagram of a battery management system of the present disclosure. The battery management system 100 (BMS) is mainly used to couple to a load 200 and provide a battery power Pb to discharge the load 200, so as to maintain a power required for an operation of the load 200. The battery management system 100 includes a positive terminal P+, a negative terminal P−, a battery pack 1, a main discharge loop 2, a pre-discharge loop 3 and a controller 4, and the battery management system 100 may be coupled to the load 200 through the positive terminal P+ and the negative terminal P−, so as to provide the battery power Pb to discharge the load 200. Among them, the battery power Pb may represent a discharge voltage Vd when the battery management system 100 discharges the load 200, or may represent a current I provided by the battery management system 100 to the load 200, or represent an output power of the battery management system 100.

Specifically, a positive end B+ of the battery pack 1 is coupled to the positive terminal P+ through a positive loop, and a negative end B− of the battery pack 1 is coupled to the negative terminal P-through a negative loop. Among them, the positive circuit may include the main discharge loop 2 and the pre-discharge loop 3. One end of the main discharge loop 2 is coupled to the battery pack 1, and the other end of the main discharge loop 2 is coupled to the positive terminal P+. The pre-discharge loop 3 is connected in parallel to the main discharge loop 2. The controller 4 is coupled to the main discharge loop 2 and the pre-discharge loop 3, and selectively controls a conduction of the main discharge loop 2 or the pre-discharge loop 3 to provide the battery power Pb of the battery pack 1 to the positive terminal P+ and the negative terminal P−. Furthermore, the battery management system 100 of the present disclosure is preferably suitable for light electric vehicle (LEV) driven by a motor. A main function of the battery pack 1 is to provide a power to a system end so that the system end (i.e., the load 200) may control and drive the motor. Since driving the motor requires a large current, usually an input capacitor Cin on the system end uses a large-capacitor capacitor (for example, but not limited to, 1000 to 4000 uF) as a voltage regulator for the power supply. Therefore, when the battery pack 1 is connected to the system end instantly, since the input capacitor Cin is equivalent to a short circuit when it is no power, a surge current that largely will be generated when it is powered on instantly. Such the surge current that largely may easily damage system component(s) or reduce their service life, and may even reversely impact component(s) inside the battery management system 100. Therefore, the battery management system 100 of the present disclosure adopts a pre-discharge operation to first charge up a voltage of the input capacitor Cin, and then turns on a main discharge function to suppress the surge current generated when the battery management system 100 is connected to the load 200 instantly.

On the other hand, the present disclosure further designs the pre-discharge loop 3. Specifically, in the battery management system 100 of the present disclosure, when the load 200 is coupled to the battery management system 100, the controller 4 may know that the positive terminal P+ and the negative terminal P− are coupled to the load 200 by receiving an external signal So, so that the controller 4 first turns on the pre-discharge loop 3 for a specific time, and then turns on the main discharge loop 2. Among them, the external signal So may be provided by the load 200, or the external signal So may also be provided by the battery management system 100 detecting itself. Therefore, the battery management system 100 may first turn on the pre-discharge loop 3 to provide a smaller current to discharge the load 200, and then turn on the main discharge loop 2 to provide a larger current to discharge the load 200. In this way, it may suppress the surge current when the battery management system 100 is connected to the load 200 instantly. In addition, the pre-discharge loop 3 will set a rated current Ia, and during the specific time that when the controller 4 turns on the pre-discharge loop 3, the pre-discharge loop 3 limits the current I to be substantially equal to the rated current Ia according to the current I flowing through the pre-discharge loop 3 reaching the rated current Ia. In this way, it may further suppress a peak value of the surge current, avoid a sudden peak excessively value that may cause abnormality in the battery management system 100 or the load 200 (system), or even cause the risk of component damage, so as to increase the service life of the component.

Refer again to FIG. 1, the battery management system 100 further includes a first detection circuit 5 and a second detection circuit 6. The first detection circuit 5 is coupled to the battery pack 1 and the controller 4, and detects the battery pack 1 to provide a battery pack parameter Sb corresponding to the battery power Pb. The controller 4 determines whether the battery pack 1 is normal according to the battery pack parameter Sb, so as to determine whether the battery power Pb may be provided to the load 200. When the controller 4 determines that the battery pack 1 is normal according to the battery pack parameter Sb, the controller 4 selectively controls the conduction of the main discharge loop 2 or the pre-discharge loop 3 to provide the battery power Pb to the load 200. On the contrary, when the controller 4 determines that the battery pack 1 is abnormal according to the battery pack parameter Sb, the controller 4 turns off the main discharge loop 2 and the pre-discharge loop 3 to avoid providing the battery power Pb to the load 200.

Furthermore, the battery pack 1 includes a plurality of batteries 12 connected in series or in parallel, and the first detection circuit 5 includes a plurality of detection circuits 52. The detection circuits 52 are respectively coupled to the batteries 12 to detect the battery parameters Sb1 to Sbn of the batteries 12 respectively, so that the first detection circuit 5 may detect the battery parameters Sb1 to Sbn of each battery 12 respectively and provide the battery pack parameter Sb (That is, the battery pack parameter Sb is the sum of the battery parameters Sb1 to Sbn). Among them, the battery pack parameter Sb may include, for example, but not limited to, parameters such as voltage, current, temperature, and power of each battery 12, as well as the condition of each battery 12 (for example, but not limited to indicating whether the battery is damaged, etc.). The second detection circuit 6 is coupled to the main discharge loop 2, the pre-discharge loop 3 and the controller 4, and detects the main discharge loop 2 or the pre-discharge loop 3. On the other hand, the negative loop may include a detection resistor Rs. The first detection circuit 5 is coupled to the detection resistor Rs, and detects a current flowing through the detection resistor Rs to determine whether an occurs that short circuit, overcurrent, leakage current, etc. in the battery management system 100.

Specifically, the second detection circuit 6 may detect the voltage, current, leakage current and other values of the main discharge loop 2 and provide a main discharge loop parameter Sm accordingly to confirm whether an occurs that overload or short circuit during discharge. Similarly, the second detection circuit 6 may also detect voltage, current, leakage current and other values of the pre-discharge loop 3 and provide a pre-discharge loop parameter Sp accordingly. Therefore, at a specific time, the controller 4 may determine whether the discharge of the load 200 by the battery management system 100 is normal according to the discharge voltage Vd and the current I that the pre-discharge loop 3 discharging the input capacitor Cin, so as to decide whether to turn on the main discharge loop 2. When the controller 4 determines that the battery management system 100 discharges the load 200 normally at a specific time, the controller 4 turns on the main discharge loop 2 so that the battery management system 100 discharges the load 200 normally. On the contrary, when the controller 4 determines that the battery management system 100 discharges the load 200 abnormally at a specific time (for example, but not limited to, the failure of the voltage to increase smoothly means that the input end of the load 200 may be short circuit), the controller 4 turns off the main discharge loop 2 and the pre-discharge loop 3 to prevent the battery management system 100 from providing the battery power Pb to the load 200. In this way, the risk of damage due to external short circuit when the main discharge loop 2 is turned on may be avoided.

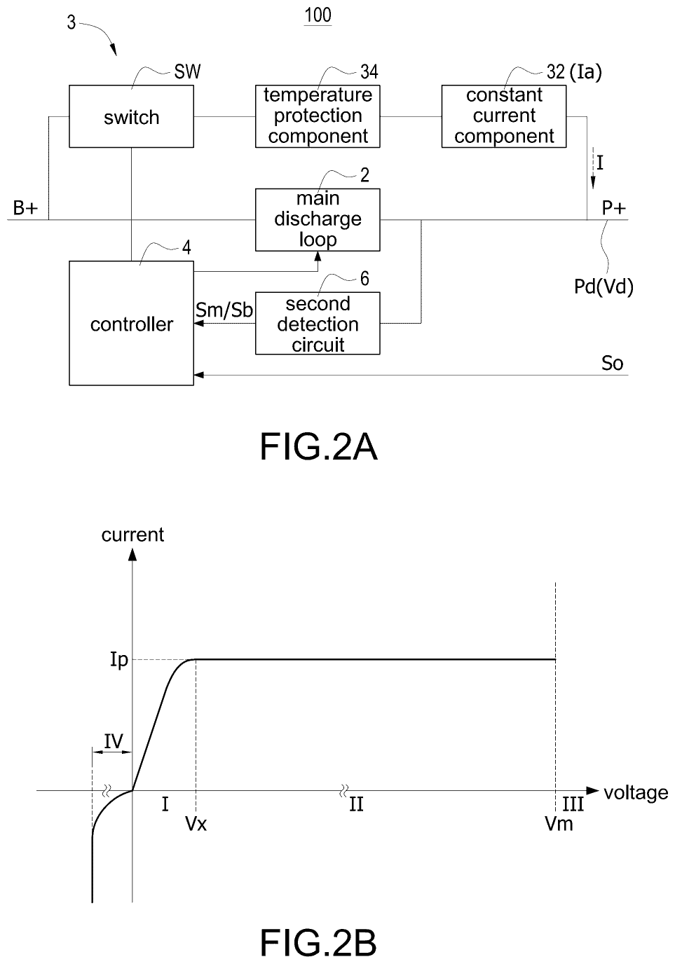

Please refer to FIG. 2A, which shows a block circuit diagram of a pre-discharge loop of the present disclosure, and also refer to FIG. 1. The pre-discharge loop 3 includes a switch SW and a constant current component 32, and one end of the switch SW is coupled to one end of the main discharge loop 2. One end of the constant current component 32 is coupled to the switch SW, and the other end of the constant current component 32 is coupled to the other end of the main discharge loop 2. Among them, the positions of the switch SW and the constant current component 32 may be interchanged with each other. At a specific time, the controller 4 controls the switch SW to be turned on, and the constant current component 32 limits the current I flowing through the pre-discharge loop 3 according to the preset rated current Ia. Therefore, when the current I reaches the rated current Ia, the constant current component 32 limits a current value of the current I to be substantially equal to the rated current Ia, so that the current flowing to the input capacitor Cin is maintained at a constant current.

Please refer to FIG. 2B, which show a characteristic curve diagram of a current regulative diode of the present disclosure. Furthermore, the constant current component 32 may preferably include at least one current regulative diode (CRD). Interval I in FIG. 2B is a linear operation region. In this interval, a voltage and current of the current regulative diode rise synchronously, and it is no constant current function. When the voltage of the current regulative diode reaches a specific voltage Vx, it enters the constant current region of interval II. In interval II, even if the voltage of the current regulative diode continues to rise, the current of the current regulative diode is maintained at a specific current Ip to provide a constant current function. Until the voltage of the current regulative diode exceeds an upper limit voltage Vm, the current regulative diode enters interval III.

In interval III, the current of the current regulative diode cannot be maintained at the specific current Ip but continues to rise. Therefore, in this interval, the current of the current regulative diode is too large and may easily lead to breakdown. On the other hand, interval IV is the reverse region. The characteristic curve of the current regulative diode in this range is similar to the characteristic curve of a general diode in the forward direction, and it is a condition where the diode is turned on. Therefore, If the constant current component 32 in FIG. 2A uses the current regulative diode, it is no need to use an additional controller 4 to provide a control signal to control the constant current component 32. So that, the constant current component 32 may passively limit the current I flowing through the pre-discharge loop 3 to the rated current Ia, so as to provide the effect that the input capacitor Cin of the load 200 is charged with a constant current. In this way, an effect that a control error of the controller 4 may be reduced and the design may be simplified may be achieved.

On the other hand, a level of the rated current Ia may be set by a circuit designer according to a requirement of the load 200. Specifically, when the input end of the load 200 may withstand a larger current, the constant current component 32 may provide a higher rated current Ia through the parallel connection of multiple current regulative diodes. On the contrary, if the constant current component 32 only uses a single current regulative diode, the rated current Ia is the specific current Ip. Therefore, the number of the constant current diode(s) is proportional to the level of the rated current Ia. In one embodiment, the constant current component 32 is not limited to using the above-mentioned constant current diode. Therefore, regardless of whether it needs to be actively controlled by the controller 4 or does not need to be controlled by the controller 4, as long as the constant current component 32 may achieve the effect that the current I is limited to be substantially equal to the rated current Ia when the current I flowing reaches the rated current Ia, it should be included in the scope of this embodiment.

Referring again to FIG. 2A, the pre-discharge loop 3 may further include a temperature protection component 34. The temperature protection component 34 is coupled to the switch SW and the constant current component 32, and the temperature protection component 34 is mainly used to protect the pre-discharge loop 3 from over-temperature to prevent the current I on its path from being too large and causing damage to the components on this path. Moreover, if the pre-discharge loop 3 includes the temperature protection component 34, the positions of the switch SW, the constant current component 32 and the temperature protection component 34 may be exchanged with each other. Among them, the temperature protection component 34 may preferably be a positive temperature coefficient resistor. The main reason is that the positive temperature coefficient resistor provides impedance as its temperature changes. The higher the temperature, the greater the impedance, and otherwise the lower it is. Therefore, when the temperature is higher, the temperature protection component 34 may reduce the rated current Ia in a disguised manner by increasing the impedance. Otherwise, the rated current Ia currently preset by the constant current component 32 is maintained. Therefore, the level of the rated current Ia is inversely proportional to the level of the impedance.

Since the temperature protection component 34 uses the positive temperature coefficient resistor, it is no need to use the controller 4 to provide the control signal to control the temperature protection component 34, so that the temperature protection component 34 may passively perform over-temperature protection. In this way, the effect that a control error of the controller 4 may be reduced and the design may be simplified may be achieved. In one embodiment, the temperature protection component 34 is not limited to using the above-mentioned positive temperature coefficient resistor. Therefore, regardless of whether it needs to be actively controlled by the controller 4 or does not need to be controlled by the controller 4, as long as the temperature protection component 34 may achieve the effect that reducing the rated current Ia for over-temperature protection, it should be included in the scope of this embodiment. On the other hand, since the controller 4 controls the discharge operation of the battery pack 1 by controlling the turn-on/off of the switch on the path of the main discharge loop 2 or the pre-discharge loop 3, if a drive capability of the controller 4 is insufficient, the battery management system 100 may also optionally include a switch drive circuit (not shown) to drive the switch(es) on its path. On the contrary, if the drive capability of the controller 4 is sufficient, it is not subject to this limit. In one embodiment, the couple relationship and operation method of the circuit components not described in detail in FIG. 2A are similar to those in FIG. 1 and will not be described again here.

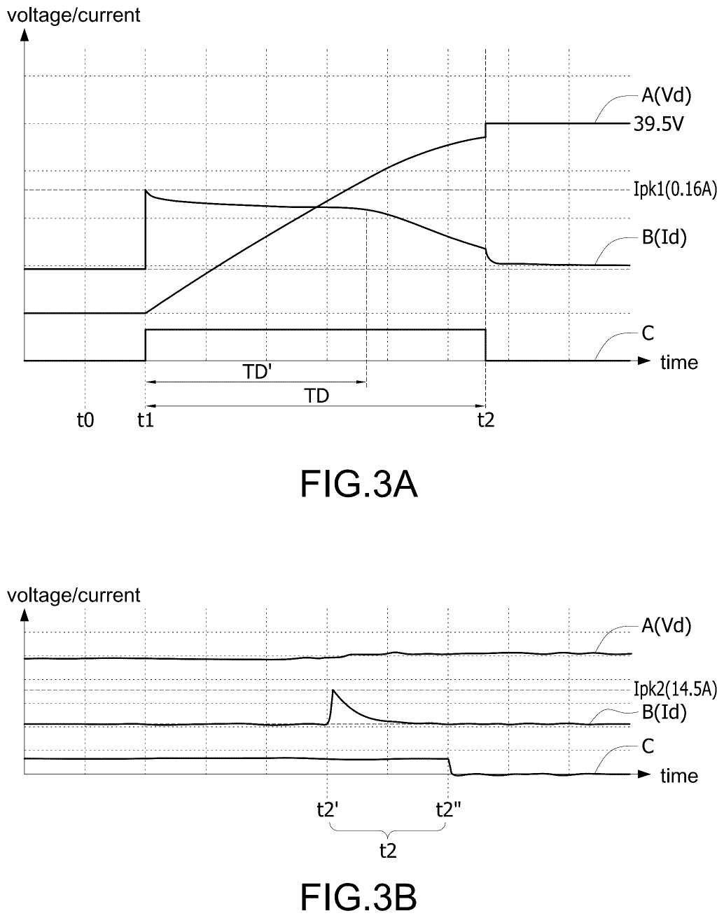

Please refer to FIG. 3A, which shows a schematic waveform diagram of a constant current component using the current regulative diode of the present disclosure, FIG. 3B, which shows a schematic waveform diagram of the main discharge loop being turned on at time t2 in FIG. 3A, and also refer to FIG. 1 to FIG. 2B. The waveform in FIG. 3A mainly shows the waveform diagram using two current regulative diodes connected in parallel to form the constant current component 32. Among them, the packaging of current regulative diodes is SMA (length*width is 4.3*2.6=11.18 mm), so that the area formed by the space of two current regulative diodes (2 pcs) is 11.18*2=22.36 mm2. In addition, in FIG. 3A and FIG. 3B, curve A is the discharge voltage Vd when the battery management system 100 discharges the input capacitor Cin, curve B is a discharge current Id when the battery management system 100 discharges the input capacitor Cin (at a specific time TD, the discharge current Id is the current I flowing through the pre-discharge loop 3), and curve C is a duration of the specific time TD. Before time t0, the load 200 has not yet been coupled to the battery management system 100, so the specific time TD has not yet started, and both the discharge voltage Vd and the discharge current Id are zero. At this time, the controller 4 has not yet turned on the main discharge loop 2 and the pre-discharge loop 3, so that the battery power Pb cannot be provided to the positive terminal P+.

After time t0, the load 200 is coupled to the battery management system 100, and the controller 4 detects the coupling of the load 200 and turns on the switch SW. Therefore, the pre-discharge loop 3 is turned on and the current I flowing through the pre-discharge loop 3 to start the specific time TD. Since the input capacitor Cin is equivalent to a short circuit when it is no power, a huge surge current (that is, the current generates a spike) will be generated when it is powered on instantly. Moreover, since the characteristics of the current regulative diode, when the current I reaches the rated current Ia, the current regulative diode may limit the current I substantially equal to the rated current Ia (a peak value Ipk1 is approximately 0.16 A). Time t0 to t1 is a specific time period TD′ of the specific time TD, and since the current regulative diode may limit the current I substantially equal to the rated current Ia, so a rising slope of a discharge voltage Vd is substantially a constant slope (that is, the slope is substantially 1).

On the other hand, it can be seen from FIG. 3A that at time t1, because the pre-discharge loop 3 is turned on, the current I instantly increases to the peak value Ipk1, and then gradually decreases. Therefore, the “substantially” may be defined as the range of 80% to 100% of the peak value Ipk1, and this range may be adjusted according to the needs of those skilled in the art, and it is not limited to this.

At time t1 to t2, since the input capacitor Cin has been charged to a certain level (39.5V), an energy required by the input capacitor Cin gradually becomes smaller, causing the current I to gradually decrease from the rated current Ia. When the time t2 reaches, the pre-discharge operation of the battery management system 100 to the load 200 has been completed, so the specific time TD ends. At this time, the controller 4 turns off the pre-discharge loop 3 and turns on the main discharge loop 2. Therefore, at time t2, the controller 4 turns on the main discharge loop 2 to generate a second surge current. FIG. 3B is a schematic waveform diagram of the main discharge loop turning on at time t2 in FIG. 3A, and the controller 4 turns off the pre-discharge loop 3 at time t2′ and turns on the main discharge loop 2. Therefore, when the loop is switched instantly, the main discharge loop 2 generates a peak value Ipk2 (i.e., surge current) of approximately 14.5 A. In general, if the main discharge loop 2 is directly turned on, there will be 100 A peak value Ipk2 or higher on the main discharge loop 2 (that is, surge current, this current is not a fixed value, it only represents the embodiment of the present disclosure), and the peak value Ipk2 excessively may easily cause the entire battery management system 100 or the load 200 to accidentally enter the protection state. However, after the pre-discharge operation of the disclosed pre-discharge loop 3 of the present disclosure, only 14.5 A peak value Ipk2 is generated when the main discharge loop 2 is turned on. Moreover, at time t2″, the controller 4 determines that the loop switching has been successfully completed, and therefore the specific time TD ends.

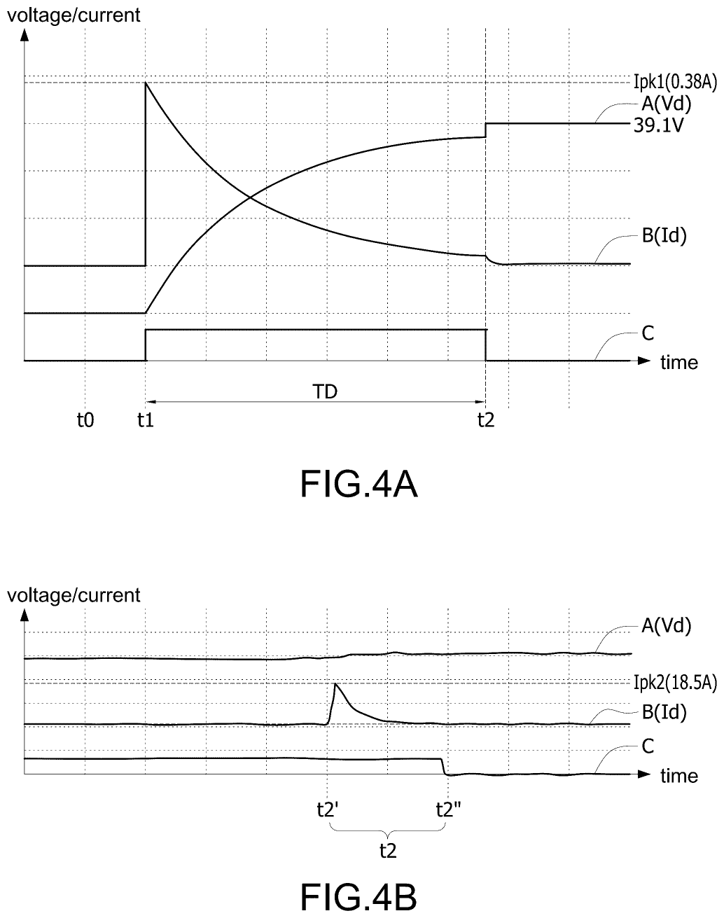

Please refer to FIG. 4A, which shows a schematic waveform diagram in which the constant current component is replaced with a current limit component using a resistor of the present disclosure, FIG. 4B, which shows a schematic waveform diagram of the main discharge loop being turned on at time t2 in FIG. 4A, and also refer to FIG. 1 to FIG. 3B. The waveform in FIG. 4A mainly shows the waveform diagram in which the two current regulative diodes of constant current component 32 are replaced with resistors. Among them, the packaging of resistors is 2512 (length*width is 6.35*3.1=19.685 mm), so that the area formed by the space of two resistors (2 pcs) is 19.685*2-39.37 mm2. Since the area of the current regulative diodes used in the constant current component 32 is only 22.36 mm2, the area is reduced by 43.2% [(39.37−22.36)/39.37)*100%] in the same 2 pcs space on the circuit board. Therefore, using the current regulative diode may save circuit space and improve a space utilization of the battery management system 100.

In addition, FIG. 4A and FIG. 4B are similar to FIG. 3A and FIG. 3B, curve A is the discharge voltage Vd when the battery management system 100 discharges the input capacitor Cin, curve B is the discharge current Id when the battery management system 100 discharges the input capacitor Cin (at the specific time TD, the discharge current Id is the current I flowing through the pre-discharge loop 3), and curve C is a duration of the specific time TD. In FIG. 4A, since the constant current component 32 is replaced by the current limit component formed by using the resistor in parallel, the current I will produce a logarithmic discharge curve that the resistor and the input capacitor Cin to the load 200 (i.e., I(t)=E/Re−t/RC). Moreover, the current limit component also does not have the ability to limit the current peak value, so the peak value Ipk1 of approximately 0.38 A is generated when the pre-discharge loop 3 is turned on instantly at time t1.

Therefore, the current I discharged by the battery management system 100 to the load 200 becomes smaller as time increases, and the current limit component changes with the capacitance value of the input capacitor Cin. In order to cope with the above situation, if the battery management system 100 uses the current limit component, a current withstand specification of the battery management system 100 must be improved to cope with the situation of large instantaneous power, which will inevitably increase the circuit cost and circuit volume. However, if the battery management system 100 uses the constant current component 32, the current I discharged by the battery management system 100 to the load 200 is less affected by time, and the constant current component 32 has no correlation with the capacitance value of the input capacitor Cin. Therefore, if the battery management system 100 uses the constant current component 32, the surge current during startup may be greatly suppressed and it is no need to increase the current withstand specification of the battery management system 100 to cope with the situation of large instantaneous power, so that its safety is higher than the current limit component.

In FIG. 4B, since the input capacitor Cin has been charged to a certain level (39.5V), an energy required by the input capacitor Cin gradually becomes smaller. Therefore, when the time t2 reaches, the controller 4 turns off the pre-discharge loop 3 and turns on the main discharge loop 2. When the loop is switched instantly at time t2′, the main discharge loop 2 generates the peak value Ipk2 (i.e., surge current) of approximately 18.5 A. Moreover, at time t2″, the controller 4 determines that the loop switching has been successfully completed, and therefore the specific time TD ends. Since the number of components is the same and the specific time TD is also the same, the discharge voltage Vd of the constant current component 32 has exceeded the current limit component at the end of the specific time TD. Therefore, when the main discharge loop 2 is turned on at time t2, the peak value Ipk2 using the constant current component 32 may be reduced by 21.6% [(18.5−14.5)/18.5)*100%].

Therefore, in summary, for various applications of light electric vehicle (LEV), using the current limit component requires selecting different resistors according to various conditions and calculating the power accordingly. However, using the constant current component 32 only requires increasing the number or adjusting the specific time TD, which may provide a better surge current suppression effect and may also stabilize the increase in the discharge voltage Vd. Therefore, it is no need to specifically design the battery management system 100 to make it convenient to use. In addition, the pre-discharge function is that “confirming whether the load 200 is normal and reducing the surge current generated when the main discharge circuit 2 is turned on”. Therefore, if the load 200 is short-circuited, the current limit component will be unable to withstand excessive power. Moreover, if abnormal conditions occur repeatedly, it will cause circuit damage and cause safety issues. However, the constant current component 32 outputs the rated current Ia, and it may also be selectively matched with the temperature protection component 34 for further protection.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A battery management system configured to discharge a load having an input capacitor, and the battery management system comprising:
a battery pack,
a main discharge loop coupled to the battery pack and the input capacitor,
a pre-discharge loop connected in parallel with the main discharge loop, and the pre-discharge loop configured to set a rated current, and
a controller coupled to the main discharge loop and the pre-discharge loop, and the controller configured to selectively control a conduction of the main discharge loop or the pre-discharge loop to provide a battery power of the battery pack to the load,
wherein, the controller first turns on the pre-discharge loop for a specific time, and then turns on the main discharge loop when the load is coupled to the battery management system, and the pre-discharge loop limits a current substantially equal to the rated current according to the current flowing through the pre-discharge loop reaching the rated current at the specific time.

2. The battery management system as claimed in claim 1, wherein the pre-discharge loop comprises:
a switch coupled to one end of the main discharge loop, and
a constant current component with one end coupled to the switch and the other end coupled to the other end of the main discharge loop,
wherein, the controller controls the switch to be turned on, and the constant current component limits the current substantially equal to the rated current according to the current flowing through the constant current component reaching the rated current at the specific time.

3. The battery management system as claimed in claim 2, wherein the constant current component comprises at least one current regulative diode.

4. The battery management system as claimed in claim 3, wherein the number of the at least one current regulative diode is proportional to a level of the rated current.

5. The battery management system as claimed in claim 2, wherein the pre-discharge loop further comprises:
a temperature protection component coupled to the switch and the constant current component, and the temperature protection component configured to provide an over-temperature protection of the pre-discharge loop.

6. The battery management system as claimed in claim 5, wherein the temperature protection component is a positive temperature coefficient resistor and is configured to provide an impedance corresponding to a change with temperature, and a level of the rated current is inversely proportional to a level of the impedance.

7. The battery management system as claimed in claim 1, further comprising:
a first detection circuit coupled to the battery pack and the controller, and the first detection circuit configured to detect the battery pack to provide a battery pack parameter corresponding to the battery power,
wherein, the controller determines whether the battery pack is normal according to the battery pack parameter, so as to determine whether to provide the battery power to the load.

8. The battery management system as claimed in claim 7, wherein the battery pack comprises a plurality of batteries, and the first detection circuit is configured to detect a plurality of battery parameters of the batteries, so as to provide the battery pack parameter.

9. The battery management system as claimed in claim 1, further comprising:
a second detection circuit coupled to the pre-discharge loop and the controller, and the controller configured to determine whether the battery management system being discharged the load normally according to a voltage and a current of the pre-discharge loop at the specific time, so as to determine whether to turn on the main discharge loop.

10. The battery management system as claimed in claim 1, wherein a rising slope of a discharge voltage of the input capacitor is substantially a constant slope during a specific time period of the specific time.
